(19) United States
(12) Patent Application Publication
(10) Pub. No.: US 2002/0141548 A1
(43) Pub. Date: Oct. 3, 2002

(54) Database maintenance method and system for use in a communication network

(76) Inventor: Peter Boda, Helsinki (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/106,242

(22) Filed: Mar. 27, 2002

(30) Foreign Application Priority Data
Mar. 27, 2001 (EP) 01107605.6

(51) Int. Cl. H04M 1/64; H04M 3/00

(52) U.S. Cl. 379/88.01; 379/355.02

(57) ABSTRACT

A contact database maintenance method comprises the steps of storing used contact information, collecting data associated to used contact information, providing the contact information to a terminal device, and offering maintenance operations of said contact database to a user based on these contact information and associated data.

### BACKGROUND OF THE INVENTION

The invention relates to communication networks having a database that relates contact information to names, e.g. name dialling systems. It also relates generally to voice dialling systems using spoken names to enter the destination of the call, and to voice dialling systems using users' personal name directories. In particular, the invention relates to a method and system for maintaining a contact database that is adapted to maintain personal name directories of a voice dialling system, and to a computer program and computer program product adapted to carry out said maintenance method, to a terminal device and a server in which said maintenance method is carried out.

Personal databases can be used in dialling systems (separately or as an addition to e.g. corporate databases), or in other parts of the communication network. The databases of private intelligent communication networks and dialling systems, especially of voice dialling systems require regular maintenance to ensure reliable and efficient operation. To simplify the use of communication networks, especially of private intelligent communication networks, and to enhance the comfort of the communication device user, the input of a communication destination can significantly be improved by a voice input instead of a number dialling operation. This is because people tend to easily forget contact information and in hands/eyes-busy situations, e.g. driving, voice dialling provides enhanced safety.

Voice dialling systems known in the art are described in the U.S. Pat. No. 5,942,070, ×U.S. Pat. No. 6,154,526 and in U.S. Pat. No. 5,917,891.

The U.S. Pat. No. 5,924,070 describes a classic voice dialling system, and a method of its operation. The names are stored along with the telephone number in user personal databases.

The U.S. Pat. No. 6,154,526 describes a data acquisition and error correcting speech recognition system and a method of its operation, for the use in a voice dialling system. The system involves a dialogue between the user and the voice dialling system, wherein the system repeats the dialled telephone numbers. This system is able to add entries to the database automatically. It can be used in environments, where users cannot manipulate a keypad such as in-car or on-motorbike applications.

The U.S. Pat. No. 5,917,891 describes a voice-dialling system using an adaptive model of calling behaviour. The adaptive calling behaviour model increases the performance with the available behaviour data of the users. If the system can detect that the user keeps calling only two certain numbers each Friday afternoon, the system increases the performance by only distinguishing between the names related to these two numbers (in other words part of the language model used for the speech recognition process is modified in order to emphasise the increased likelihood of two certain numbers). The main drawback of this system is that rarely used telephone numbers tend to show no use behaviour patterns.

All these systems have in common that the system performance is related to the number of name entries in the personal database. To keep the system performance high, the database has to be maintained, new entries have to be made, and even more important, useless entries have to be deleted. The maintenance of the databases has to be executed by a network administrator, or the user himself. Users tend to forget the maintenance task and thus the recognition performance of the dialler system decreases. Further, the user tends to keep rarely used name entries, because the user easily forgets these rarely used numbers and as a consequence, the size of the database increases thus decreasing recognition performance. Additionally, all these Systems are limited to telephone networks.

To increase the performance of a contact database for name dialling it is important to maintain or update the database periodically. For example, to keep the performance of a voice dialling process, there is a need for a database maintenance system that is capable of updating the database of the voice dialling system.

### SUMMARY OF THE INVENTION

One object of the invention is to provide a system and a method to maintain databases in communication networks and dialling systems to increase their performance. Further, a computer program and computer program product for carrying out said method, as well as a terminal device and a server should be provided.

Another object of the invention is to simplify the maintenance of the personal name directories in communication networks or name dialling systems.

This is achieved according to one aspect of the invention, by a method for maintaining a database in a communication network according to claim 1. It comprises the steps of storing used contact information, collecting data associated to used contact information, providing said contact information to a terminal device, and offering maintenance operations to a user based on this contact information and associated data.

By storing the contact information called, the retransfer of this contact information to the same or another terminal device can be executed any time later. By collecting data associated to used contact information, the system can show the user to how important a maintenance operation is. The associated data can be data for statistics, statistics, temporal rules other information from the contact database like organisation structure etc. By transferring the contact information to a terminal device, the user can decide by himself/herself if he/she wants to maintain his/her personal telephone directory in the contact database.

Preferably, the step of maintaining comprises an addition of data, advantageously, the step of maintaining comprises a deletion of data, and conveniently, the step of maintaining comprises a modification of data, or a reminding of said user. Especially the reminding of the user is an extraordinary indirect way to maintain a contact database, because the entries in the contact database are not directly changed, but the user was encouraged to use the database. So the system tries to change the behaviour of the user to optimise the overall contact performance, instead of trying to adapt to an arbitrary behaviour of the user.

Preferably, the contact information is a telephone number. This is especially useful for name and voice dialling system in connection with PBX, or for voice/name dialling systems in mobile terminal devices. It is very useful for mobile terminal devices in connection with voice generated short messages too, so that a user can generate, address and post a message like SMS just by voice.

Advantageously, the contact information is an e-mail or internet address. With the help of this contact database information system the user can maintain in a first stage a name dialling system. This name dialling system is very useful, if certain internet sites can easily be chosen even though the desired company, product or like can be found under difficult memorable internet addresses. It is to be understood that internet addresses can also be single internet sites. In a second stage these internet addresses may be re-selected by a voice enabled input. Preferably, as in the case of phone applications, wherein the user has to pick up a telephone receiver, the user may have to press a key to start the voice enabled internet address input. This can be useful to prevent the system from auto surfing if the system coincidentally receives internet addresses, spoken, e.g., to another person on a telephone.

Conveniently, the contact information is a WAP access point. By using WAP, SMS or other mobile phone usable contact information, the limited storage space especially in mobile terminal devices can be used in an optimised way. It is to be understood that the present invention is not limited to the mentioned embodiments of the present GSM or other communication standards, but is also applicable to any communication network.

Preferably, the method for maintaining a contact database further comprises the option of using name dialling operation. In this case, the contact information is transferred to the terminal device if the name dialling option has not been used to dial the contact information. By transferring dialled contact information from the communication network to the database maintenance system, the system can, by referring to the database of the name dialling system, create a list of those contact information dialled without the use of the name dialling system. This enables the database maintenance system to transfer the contact information to a user terminal for offering to add the contact information to the personal user directory. This also enables the database maintenance system to remind the user that he/she already has entered a name and a contact information in the voice dialling system, to encourage the user, in case that particular contact information is used rarely, to use the voice dialling system to dial the contact information.

Preferably, the contacted contact information are contacted to by voice dialling. By using voice dialling the user can dial without using his/her hands. Voice dialling can be executed by voice-enabled name dialling, i.e. when a name is uttered by the user and recognised by the system, and by voice-enabled number/letter dialling, i.e. when the full contact information is uttered by the user and recognised by the system. The voice dialling system includes that both the voice dialling system and the database system may be set to a passive state, as e.g. a handicapped person who can not use the voice dialling system for sending e.g. a FAX, and surely doesn't want to be periodically reminded to use it. It is to be understood that the expression “voice” is synonymously used for every sound directly or indirectly generated from a user. This sound is not limited to sounds generated by the vocal cords of the user. The sound may be generated by whistling, clapping or even knocking or the like without the direct use of the vocal cords.

Advantageously, the method for maintaining a database in a communication network further comprises the step of generating statistics comprising the number of calls made to a specific contact information during a predetermined interval. By generating statistics of how often a certain contact information is contacted, the system can decide on whether the contact information should be offered to the user to be added to the user's personal directory. Additionally, in the case of a voice dialling system, the maintenance system may detect the probability that the name, to be associated to the offered contact information, that may be entered is similar in phonological sense from pronunciation point of view to other names previously entered and contained in the personal directory of the user. In response to the user entry, the system may even offer a similar, but phonetically distant name so that the user only has to answer by yes/no in order to enter the name into her/his personal directory. Very similar names affect the accuracy of recognition process, because the more similar names are present in a name directory the more frequently misrecognition occurs.

Advantageously, the offer to add a contact information to a database is transferred via a message. By transferring the offer to maintain the personal directory via a message system, the user can be reminded to maintain the user directory even if the user has actually no access to the terminal device he/she uses for telephony, or if the telephone device is not able to perform the steps required for the execution of the maintenance. The message can be transferred via electronic mail (e-mail), short message system (SMS), wireless application protocol (WAP), computer generated voice message, or any other suitable message system. The message may even be a computer generated voice message, to enable blind persons to maintain their personal contact database, especially because blind persons benefit from a voice dialling system, as blind persons can not easily dial or note contact information. The message can even be a reply postcard enclosed to a telephone bill.

Preferably, the user transfers a maintenance order via a message system and advantageously, the method for maintaining a database further comprises the step of automatically executing a maintenance order. If the voice recognition system is smart enough, it may automatically recognise the name uttered by the user, search for the name related to this contact information in other user directories or in public directory assistance database if access is allowed and finally produce a textual form of the uttered name and a corresponding contact information ready for storage in the users personal directory. An intelligent voice recognition system may even extract the name from a voice sequence at the beginning of a call, e.g. search for the first name following a salutation.

Preferably, the statistics is used for offering a deletion of said transferred contact information and said related name from said directory. By offering the deletion of names from the directory, the system can provide full maintenance to the database. In voice dialling systems, the system may even offer to change names in the directory to improve the overall performance of the voice dialling system in case that a misrecognition and subsequent cancellation by the user occurs due to phonologically close pronunciation of names. Less frequently used voice contacted contact information such as a telephone number or an e-mail address can be offered for deletion to increase the overall performance of the voice dialling system. The invention relates further to a method of reminding users, based on their calling pattern to maintain their personal name directories in order to increase the overall system performance.

Advantageously, the method for maintaining a database, further comprises the step of automatically maintaining the contact database according to said statistics. This feature can help to automatically maintain names/contact information and even personal directories. For example, rarely used contact information can be deleted after 1.5 years, often used contact information can be deleted after 2 years, and personal directories can be deleted after 3 years. This would enable the system to keep contact information for more than one year, prior to automatic deletion, so that contact information for use in seasonal requirements will not be deleted. Additionally, if a user quits the system, her/his personal directory is deleted after 3 years, even if an administrator forgot to delete the directory. With this feature it can be prevented, that the system is crowded by old invalid personal directories.

According to another aspect of the present invention, a computer program is provided, by which implementation of a method for maintaining a database according to the present invention can be executed. By using a computer program for the execution of the method for the maintenance of a database, the method can easily be implemented in computer based communication networks, such as ISDN (Integrated Systems Digital Network) or the like where the user is identified by means of an available calling number. The method according to the invention can easily be implemented in computer based voice dialling systems, too.

According to another aspect of the invention, a computer program product is provided having a storage medium which contains a program for the execution of a database maintenance method.

According to yet another aspect of the invention a terminal device is provided which is capable of maintaining a telephone directory and comprises means for storing a contacted contact information, means for determining how the contact information has been entered, means for processing data and means for posting a database maintenance offer to the user.

Preferably, the terminal device further comprises or is arranged to be connected to means for automatically generating messages and means for automatically posting messages to another terminal device.

Advantageously, the terminal device, further comprises voice recognition means. Conveniently, the terminal device is a mobile phone, and preferably, the terminal device is connected to, is incorporated in, or comprises a computer device. By maintaining a name dialling database in a terminal, the system prevents the database from requiring more storage space than necessary.

According to another aspect of the present invention a server is provided in a network, capable of executing the method of claims 1 to 15 to maintain a contact database, that comprises means for accessing the contact database, means to store and to process data, and means to post a message to a user of the database.

Preferably, the server further comprises voice recognition means and advantageously, the server further comprises a name dialling system. With the server comprising voice recognition means, and a name dialling system, the server can execute all the steps of the maintenance method according to the present invention.

According to another aspect of the invention a contact database maintenance system in a network is offered, having terminal devices and server, comprising means for storing dialled contact information, transferring dialled contact information and related data from a communication network to a terminal device, and means for maintaining said contact database and means for transferring messages to a terminal.

By transferring data from a communication network to a terminal device, the user can be reminded to maintain his/her personal directory. He/She can be asked in the message to enter a name to add with the contact information into the database, or to cancel the operation. The database maintenance system can operatively be integrated in other computing devices in the communication network. The invention is not limited to communication networks, but can be used in other networks, e.g., telephone networks, local area networks, SMS, WAP or other general communication networks. It has to be appreciated that the terminal device may be different from the terminal device used for the originating call. For example, the contact information can be transferred via e-mail to a user accessible terminal of the communication network. The transfer method can be electronic mail (e-mail), short message system (SMS), wireless application protocol (WAP), computer generated voice message, or any other suitable message method.

Preferably, in the database maintenance system the database is connected to a name dialling system. Both can be located in the communication network. Name dialling systems, especially with keyboards enable the user to enter a typed name instead of a number and require therefore a keyboard. Such name dialling systems can be used, e.g., if the telephone is implemented in a computer having a headset or the like. The name dialling system can be used to type in a product name for browsing to the homepage of a company fabricating this product instead of typing in some kind of http://www.#####.### of the like.

Advantageously, the database maintenance system can be used in a terminal device that comprises means for displaying a message on a terminal device. The message can comprise an offer for adding a displayed contact information and a related name entered by said terminal device to a directory in a database. The implementation of the system in a handset such as a cellular phone or a car-phone allows to use the relatively limited storage space to save the resources of the terminal device.

Advantageously, the database maintenance system maintains the database of a voice recognition system, e.g. for performing voice dialling with a name dialling system. By maintaining/updating the database of a voice dialling system, the system performance can be kept high, if new entries are made, and even more important, useless entries can be deleted. The performance of a voice recognition operation is roughly inversely proportional to the number of name entries in the database, that can be distinguished. Therefore the number of name entries has to be kept as low as possible.

Conveniently, the database maintenance system comprises a voice pattern recognition system. A voice pattern recognition system enables the system to identify a specific speaker. This enables a user to be identified by the system, even if the user is actually not using the terminal device related to him/her. This embodiment of the present invention may easily implemented, as the system already needs a powerful signal processing devices.

Preferably, the database maintenance system further comprises means to generate user call statistics in predetermined intervals comprising the number of calls made to a specific contact information. The specific contact information is either part of the personal directory or a called number dialled without the intervention of the voice dialling system.

By preparing user call statistics, the system can detect whether the personal name directory is up to date or requires maintenance. This enables the system to decide if a user should be urged to maintain/update his/her personal directory or not. It is an important feature of the invention, that the system does not inquire the user if no maintenance is necessary. The statistics has to be generated periodically, to keep the system maintained. The period can be time-dependent, such as day, week, month or year, and the statistics may be kept for longer periods. The period can also be related to the number of calls so that, e.g., the statistic is prepared after each hundredth call. The user call statistics may comprise an addition/deletion offer characteristics with a hysteresis, preventing continuous deletion/addition offers to a single contact information/name pair.

Advantageously, the database maintenance system further comprises means for deleting or adding a specific contact information and related data from or to said directory in a database. By deleting or adding or modifying name and contact information entries, the maintenance of the database can be executed.

Advantageously, the database maintenance system maintains the database of a speaker-dependent voice recognition system. By using a speaker-dependent voice recognition system for the voice dialling system in the network or the terminal device, the dialling performance can be increased significantly.

Preferably, the database maintenance system maintains the database of a speaker independent voice recognition system. By using a speaker-independent voice recognition system in the voice dialling system, the memory space and computing requirements of the system can be reduced. On the other hand, by using a speaker-dependent voice recognition system, the performance of the system can be improved. The best results can be expected from voice dialling systems using a combination of a speaker-dependent and speaker-independent voice recognition system.

Conveniently, the modules of the database maintenance system can be distributed between the terminal device and communication network. The distribution of the modules allows it, e.g., to install a speaker-independent voice recognition system in a terminal device, and a speaker-dependent voice recognition system in a server or in a communication network, or vice versa. The location of the voice recognition system, can be in a voice dialling server in the network, and the database with user specific information can be located in the network and can be used, e.g., for charging for the voice dialling service or the telephone service.

Advantageously, the means for voice dialling in the contact database maintenance system is distributed between the terminal device and a server. For example, a distributed voice recognition system can comprise a signal processing means in the terminal device, for preliminary processing of the voice waveform, and a secondary processing means for of recognising the already processed voice waveform for dialling means in a voice dialling server.

### BRIEF DESCRIPTION OF THE INVENTION

In the following, the invention will be described in detail by referring to the enclosed drawings in which

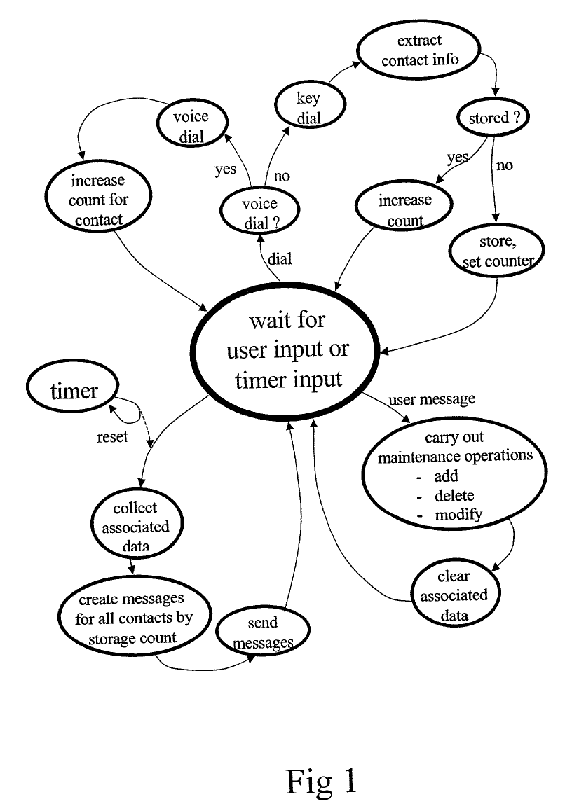

FIG. 1 shows a flowchart of the telephone database maintenance method according to the present invention.

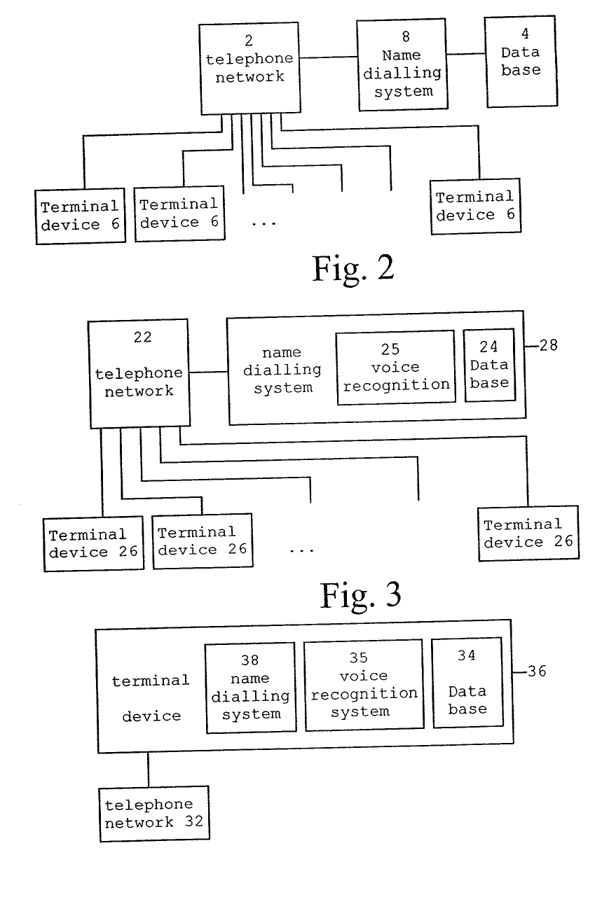

FIG. 2 shows a block diagram of a telephone network according to the invention having a name dialling system,

FIG. 3 shows a block diagram of a telephone network according to the invention with a voice-enabled name dialling system,

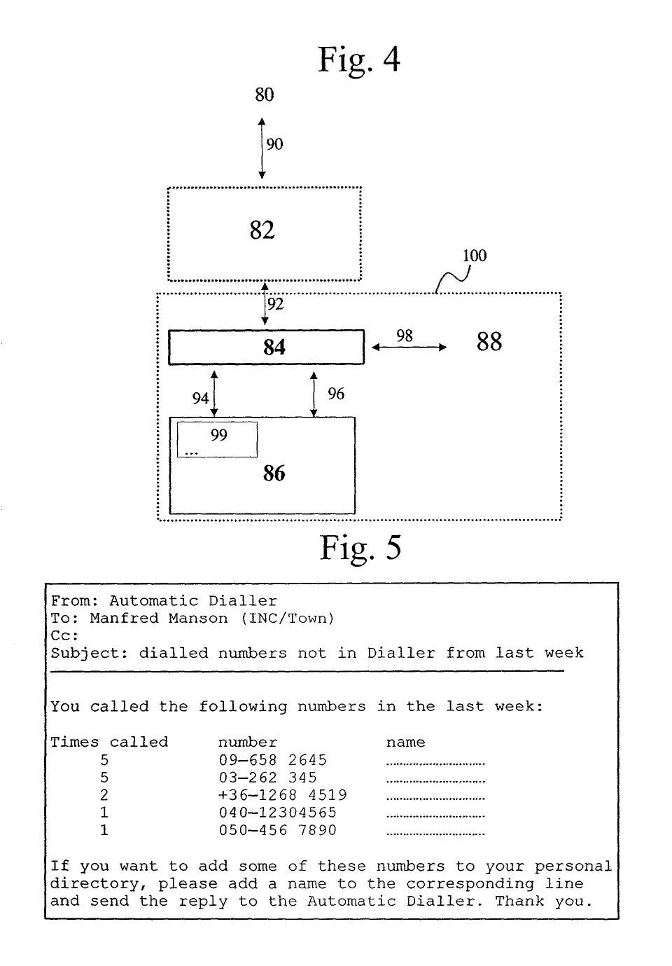

FIG. 4 shows a block diagram of a telephone terminal device according to the invention with a voice-enabled name dialling system,

FIG. 5 shows an embodiment of the present invention implementing a computer telephony utilising voice over IP,

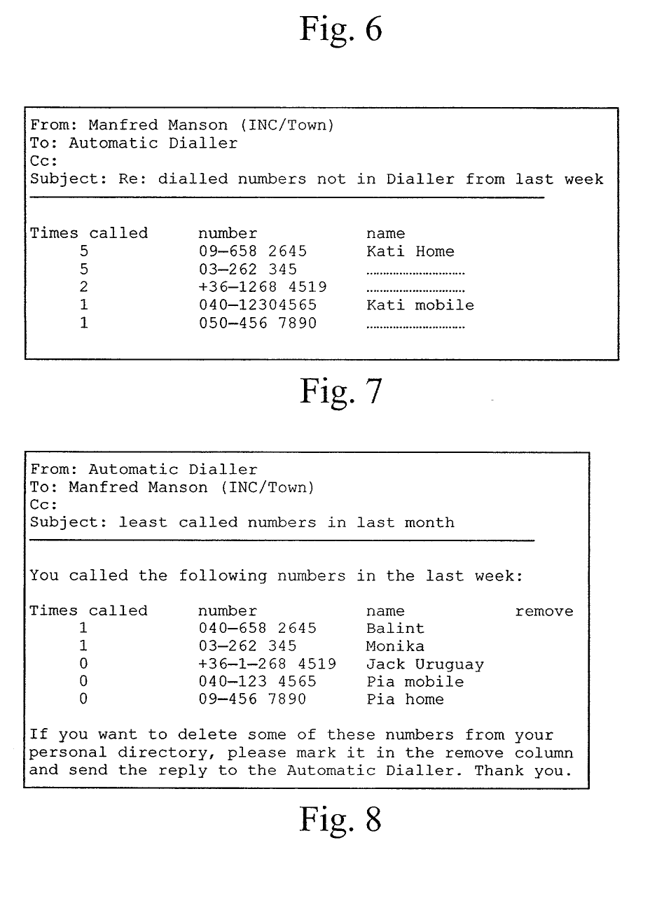

FIG. 6 shows a possible message depicting how the user can be reminded to add names to frequently used telephone numbers,

FIG. 7 shows a possible reply message depicting how the user can add names to frequently used telephone numbers,

FIG. 8 shows a possible message depicting how the user can be reminded to delete names of rarely used telephone numbers, and

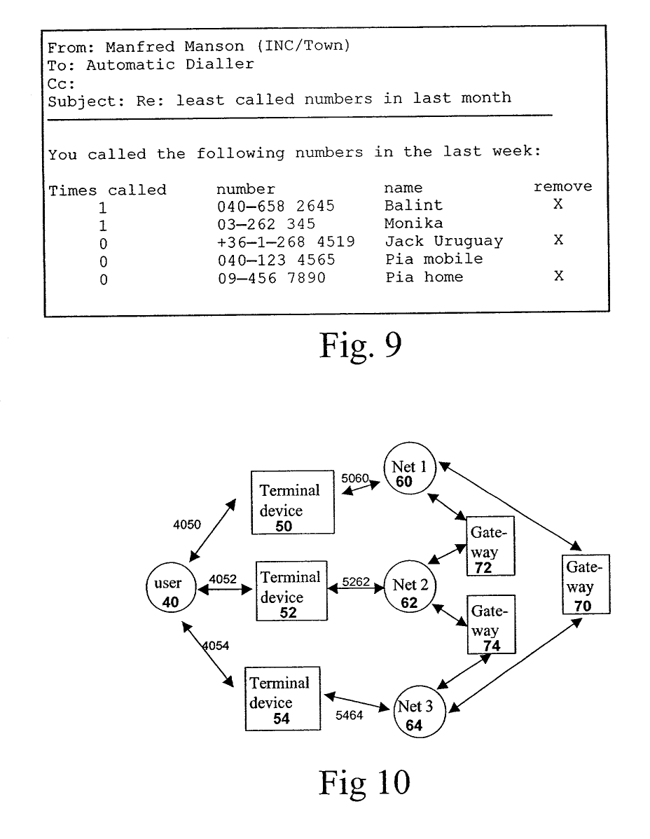

FIG. 9 shows a possible reply message depicting how the user can delete names of rarely used telephone numbers, and

FIG. 10 shows a block diagram of the maintenance system for contact databases in networks according to the present invention.

### DETAILED DESCRIPTION OF THE INVENTION

FIG. 1 is an example of the telephone database maintenance method. In the first step a user (not shown) dials a telephone number. In the second step the system determines if voice dialling operation or a key dialling operation is to be executed. If the voice dialling option is chosen, the voice dialling operation is executed, statistics about the called number is maintained (not shown) and the process is terminated and the system waits for the next dialling event. In case that the key dialling is executed, the system stores the telephone number, and then checks if the telephone number has already been stored previously. If the telephone number is not stored yet, the telephone number is stored, a new count for the telephone number is established and set to 1 and the process is terminated and the system waits for the next dialling event. In case the telephone number is already stored, the system increases the telephone number count by 1. During the process, a pre-set timer defines time intervals at which the storage count is then compared to a predetermined number n. After each time interval the timer is reset. If the number is lower than a predetermined number n, the process is terminated. If the storage count is greater than the number n, a message to the user is prepared to inform the user to maintain his telephone database, or to offer a maintenance operation. Then the stored telephone numbers which have a count exceeding the predetermined limit are deleted and the process is terminated.

FIG. 2 shows a standard telephone network 2 with a single name dialling system 8. The telephone network 2 is connected to several terminal devices 6, and to said name dialling system 8 which in turn is connected to a database 4. The network can be a private branch exchange (PBX) connected to an exterior public telephone network, or a public telephone network with a service provider providing name dialling or a computer network based solution whereas the Voice over IP (VoIP) or similar technology is used. The main drawback of the system is that users tend to forget to maintain their private name directories, leading to a decrease in the name dialling performance, due to which the user may stop using the system. In order to provide the maximum performance the user has to be reminded to maintain his/her private name directory of the user periodically. In the state of the art, name dialling system can not access telephone numbers of calls made without the use of the name dialling system. Therefore, the system can not detect, if the user dials a number frequently, but is negligent to enter the name into the name directory. This may lead to a decreased use of the name dialling system, or the user stopping to use the system. In the proposed embodiment of the invention, the PBX or the exchange in the public telephone number collect the numbers the user called without the intervention of the name dialling system and provides to the database maintenance system for further investigation.

According to the invention the telephone network 2 transfers telephone numbers dialled without the name dialling system from one terminal device to the name dialling system 8. The name dialling system 8 compares the telephone numbers with the telephone numbers stored in the private directory of the user. If a telephone number is not in the directory, the name dialling system transfers a message as depicted in FIG. 6 to a user terminal device. In the case that a user already has entered a name related to a telephone number, but keeps dialling the number manually, the system can transfer a message to the user, to encourage him/her to use the voice dialling system for calling.

The next step to ease the dialling process is to perform a voice dialling process with a voice-enabled name dialling system as shown in FIG. 3. Voice dialling is an important feature for PBXs, computer-telephony integration applications, for handicapped persons, for car-phone, automotive applications, or for people in two-busy-hands situations, in the home environment, in industry, internet and anywhere where voice recognition introduces enhanced usability, ease-of-use, efficiency and/or safety. As seen in FIG. 3, the telephone network 22 is connected to a name dialling system 28. The name dialling system 28 comprises a voice recognition system 25 and a database 24 having personal name directories and other directories (not shown). As mentioned in relation to FIG. 2, the telephone network can comprise a connection to a public telephone network (not shown). The voice recognition system can be speaker-dependent (trainable) or speaker-independent. The use and the accurate performance of the voice dialling system is dependent on the number of names that can be used for voice dialling. If the number of names is low, users tend to forget the existence of the voice dialling system. If the number is high, the performance of the voice recognition system decreases, because its performance is in inverse proportion to the number of names to be distinguished. For maximum performance of the voice dialling system, the number of names in the personal name directory has to be optimised. This requires a periodically repeated maintenance of the personal directories in the database 24. The entries in the database 24 can be changed via the terminal devices 26, or via another system, such as the use of internet-based access (not shown). The access to the database 24 requires multiple steps at least for safety reasons, so a user tends to forget to maintain his/her personal directory. On the contrary, the database maintenance system reminds the user to maintain his/her directory. Additionally, the maintenance system can offer the user to add frequently used telephone numbers by adding a related name, or delete telephone numbers with a single mouse-click in an e-mail (this is only one way, however not an exclusive mode of the communication between the database maintenance system and the user). Additionally the system may store each name/telephone combination in a separate database, for automatically re-activating the telephone/name combination in the voice dialling system, if the telephone number was frequently dialled. Then the system can send a message to the user, to inform about the change in his/her personal name directory.

FIG. 4 shows a block diagram of a terminal device 36, having an integrated voice name dialling system 38, a speaker-independent and possibly also a speaker-dependent voice recognition system 35 and a database 34. The terminal device 36 is connected to a telephone network 32. The telephone network can be a PBX, a public telephone network or a cellular telephone network or a general computer network, e.g. Internet or LAN (Local Area Network) with Voice over IP or similar capabilities. The database maintenance system is operatively integrated in said terminal device 36. The database re-displays frequently keypad dialled telephone numbers on a display (not shown) to offer the addition to the personal name directory of the speaker independent voice recognition system 35 by entering a telephone number related name. The name may be entered by keypad for the speaker-independent recogniser or by voice for the speaker-dependent recogniser. The database of the terminal device may be used for different tasks, e.g. to save telephone numbers, voice times, phone fees or other related data. The display can be located spaced apart from the phone, even with another terminal device such as a computer connected to the internet. The display can be an optical, acoustical or other display. If the voice recognition system is capable of executing voice-enabled name dialling, the system may be capable of number dialling triggered by the recognition result of spoken name and voice communication operation too. With such a system, a completely keyless terminal device 36 can be produced, e.g., a pen-phone or such.

FIG. 5 refers to an embodiment of the present invention implementing computer telephony. Forthcoming computer telephony platforms will utilise Voiceover-IP (VoIP) connectivity to telephone networks. It is thus desirable that a platform embedding the dialler solution will also have VoIP access. In practice it might mean an ISDN connection to a local PBX that is connected to a voice gateway which is connected to a VoIP network (i.e. LAN, internet). In this case the functionality described by the invention is implemented by the local PBX, exactly the same way as described above, which detects whether calls from a particular user were made without the intervention of the dialler.

Another utilisation of a VoIP connectivity is depicted in FIG. 5. It is the full end-to-end solution, where the computer-telephony is directly connected 92 to the VoIP network 82 (LAN, internet, or suchlike). The computer telephony platform or VoIP PBX 100 comprises a call manager 84 and a voice dialler 86, and a user terminal 88. In this case, the platform itself hosts necessary protocols 99, H.323, SIP, etc., that translates arriving voice packages into continuous voice stream, in the voice dialler 86, and the user terminal 88. The user terminal 88 requires the protocols to translate the continuous voice stream of a user to the VoIP standard and vice versa. The voice dialler 84 requires the VoIP protocols 99 to reassemble the VoIP data packages to a continuous (digital) voice data stream. The generation of an analogue voice signal is not necessary, but may be performed e.g. if the voice recognition system of the voice dialler can only process input.

In this embodiment the connections 92,94,98 between the call manager 84, the voice dialler 86, the user 88 and the VoIP network 82 are all VoIP connections. Furthermore, a so-called call manager 84 performs a PBX like functionality, accepts calls from the VoIP network 82, re-routes them, implements switching functionality and t call control functionality. The call manager 84 can thus implement also the call detection functionality described in the description, i.e. if a call is made without the intervention of the voice dialler 86, the call manager 84 informs the dialler 86 to initiate a request to the user 88. For the sake of clarity only one user 88 is depicted.

The voice dialler 86 can be connected to the call manager 84 via a digital data connection 96 to transfer call statistics, and a VoIP connection 94 to transfer voice for voice dialling, etc. Both connections can be put together in a single IP connection. In the case of an incoming call, an external caller 80 connects the VoIP network 82 directly via a VoIP connection 90. The call manager 84 receives the call via the direct connection 92 and routes it to the user 88 via the VoIP connection 98.

In case of an outgoing call, the user 88 connects the call manager 84 via the VoIP connection 98. The call manager 84 recognises if the call is voice dialled or standard dialled. In case of a voice dial the call manager 84 directly connects the user 88 to the voice dialler 86. After determining the desired telephone number by voice recognition, and transferring it to the call manager 84, the call manager 84 re-routes the call directly from the user to the VoIP network 82. In case of a standard dial the call manager 84 directly connects the user 88 to the VoIP network 82. Next, the call manager 84 informs the voice dialler 86 of the dialled number, so that the dialer 86 can initiate a request to the user 88, according to the description.

Of course, the method of the invention can be executed by the call manager 84, as the call manager 84 can directly receives all the information, of dialled numbers, and voice dialled numbers, and all the other information necessary to execute the method of the invention. So the call manager 84 may request the user to maintain its voice dial database.

Naturally, the platform can have mixed type of connectivity at the same time, both to a VoIP network 82 and via a main or local switch to a PSTN or mobile network (not shown).

Advantageously, any combination of the architectures shown in FIGS. 2-4 and described above is applicable for the current invention.

State of the art voice name dialling applications use speaker-independent voice recognition technology. This means that the system administrator, or the user himself/herself can add names and telephone numbers by means of textual definitions. Just by typing in a name to the system directory, e.g. “Manfred home”=09-1234567, the system forms a pronunciation model of the name which is used by the voice recognition means in the recognition phase. Adding a name to the directory and giving a corresponding number is straightforward via a web interface. Nevertheless it takes time to go to the necessary page, log in to the system with an identification step (for security reasons) and then type in the name(s) and telephone number(s).

Instead of using this long process the following process can be executed: over a predetermined period of time all dialled numbers which are called without the intervention of the voice dialler are collected in the telephone network 22. A data processing device receives a message containing the list of collected numbers from the telephone network. The collection and delivery of these numbers for any individual user is supported in current PBXs and exchanges of public fixed or mobile telephone networks or by gateways in case of VoIP implementations. The data processing device transfers the numbers of said list (FIG. 6) to the user. The user can access the message and type in the names referring to certain telephone numbers and reply to this message as depicted in FIG. 7 by sending back a completed list (the system-appended reply characters, e.g. >> can be omitted). The system will pick up those numbers from the list which have corresponding names and will append these pairs to the user's personal name directory. This phase can also be realised by a message which provides a link to the required web page which does not require any more user verification and offers the list of numbers to be associated with desired names.

Similar mechanism can be used for handset-based implementations. The basic idea is that the system can recognise the name automatically from the textual specification without any training when a name is stored in the memory with its number by means of speaker-independent recognition. According to the proposed method, if a number is called several times, the system can offer the option to add a desired name to it and to store it and thus it becomes part of the name directory. Similar mechanism is valid for the speaker-dependent case, but now the user utters the desired name and the system records it and trains a corresponding model for it to be used by the speaker-dependent recogniser. The specific number can be accessed by uttering the name instead of typing in the name or the number.

The method can be adapted such that the following parameters are adjustable by the user, e.g. via a web interface of the system: enabling or disabling the system messages, defining a delivery mode, defining the time period within which the numbers—called without the dialler—are collected, and the minimum frequency of calls within the period for a number to be included in the system message.

Instead of the tedious and lengthy method used in the state of the art for maintaining the personal name directory the following process is executed: A data processing device collects the statistics about the dialled names occurring in the personal name directory. The data processing device sends a message (FIG. 8) to the user after a predetermined time interval. The message comprises the least often voice dialled telephone numbers. The user can mark certain names and return this message as depicted in FIG. 9. The system will delete those numbers from the list and subsequently from the directory which are marked with the “remove” mark.

Similar mechanism can be used for handset-based implementations. The message can be an e-mail or a WAP, SMS, or any other suitable message. The e- mail would include a link to the user's personal name directory access page of the dialler system, with a readily offered choices to add or delete names without need of further user verification.

If the periods for the offer of adding and deleting are different, the system can prepare the delete statistics only on the basis of the names present in the personal name directory from the beginning of the period. With this, the system may prevent a deletion offer of a number being not present during the whole statistic period.

The previous figures just described telephone databases, FIG. 10 shows a block diagram of the maintenance system for contact databases in networks according to the present invention. In the Block diagram a user 40 can access three different terminal devices 50, 52 and 53. In this example the terminal device 50 is a telephone/fax combination. The telephone/fax combination has a voice activated interface 4050 and is connected via ISDN 5060 to a telephone network 60. In the telephone fax/combination, the contact database is a voice or name dialling database for telephone numbers.

In this example the terminal device 52 is a WAP- and SMS-enabled mobile phone. The mobile phone has a touch screen interface 4052 and is wireless connection 5262 e.g. to a GSM (Global System for Mobile communication) or UMTS (Universal Mobile Telecommunication System) mobile communication network 62. The contact database is a WAP-access point database.

In this example the terminal device 54 is a multimedia enabled computer. The computer has a keyboard/mouse interface 4054 and is connected via connection 5464 e.g. by Ethernet, twisted pair, glass fibre, Bluetooth™ (a kind of a wireless LAN) or like to a digital data communication network 64 like a LAN or the internet. The contact database is an e-mail database.

The different communication networks are interconnected via Gateways 70, 72 and 73, by which the different networks can exchange data. The Gateways are necessary to compile the different transmission protocols used by the different networks. The Gateways 70, 72 and 74 are connected to the respective networks 60, 62 and 64 via network connections. Each of the communication databases located in the terminal devices 50, 52, 54 or the respective networks 60, 62, 64 can post messages to the user 40. In the example, the terminal devices 50 and 52 post a message via internet to the terminal device 54, to inform the user 40 via e-mail that the respective contact databases require maintenance. In the normal case this would be the easiest way to maintain all three databases. The database maintenance systems of the networks 60, 62, 64 can co-operate to minimise the number of e-mails sent to the user 40. This may easily be achieved by synchronising the different timers of the database maintenance system in the different networks 60, 62, 64 or terminal devices 50, 52, 54. If the user 40 does not respond to the e-mails received on the terminal device 54, a next step in urging the user 40 to maintain his/her personal directories is to send a SMS to the Terminal device 52 to remind him/her to maintain his/her personal mailbox in the terminal device 54 or in the network 64. If the user 40 does not respond to this next step, the maintenance system may send a FAX via the telephone network 60 to the telephone/FAX device 50, requesting maintenance for the databases. A last step in urging the user 40 to maintain her/his personal databases is to contact the user 40 or the terminal device 52 with a computer generated voice, reminding the user to maintain her/his personal contact databases. If the system can't reach the user 40 directly, the system may leave a message in a personal voice mailbox.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

What is claimed is:

1. A method for maintaining a contact database, comprising the steps of:
storing used contact information;
collecting data associated to said used contact information;
providing said contact information to a terminal device; and
offering maintenance operations of said contact database to a user based on said information and said associated data.

2. Method according to claim 1, wherein the step of offering maintenance comprises an offering of an addition of data to said database.

3. Method according to claim 1, wherein the step of offering maintenance operations comprises an offering of a deletion of data from said database.

4. Method according to claim 1, wherein the step of maintaining comprises a modification of data, or a reminding of said user.

5. Method according to claim 1, wherein the contact information is a telephone number.

6. Method according to claim 1, wherein the contact information is an e-mail or internet address.

7. Method according to claim 1, wherein the contact information is a wireless application access point.

8. Method according to claim 1, wherein the contacted contact information are contacted to by name dialling.

9. Method according to claim 1, wherein the contacted contact information are contacted to by voice dialling.

10. Method according to claim 1, further comprising the step of generating data associated to said contact information comprising at least statistics of the contact information of contacts made to a specific contact during a predetermined interval.

11. Method according to claim 10, wherein said statistics are used for offering a maintenance of the contact information directory in said database.

12. Method according to claim 10, further comprising the step of automatically maintaining the contact database according to said statistics.

13. Method according to claim 1, wherein the offer to maintain said contact database (4) is transferred via a message.

14. Method according to claim 1, wherein the user transfers a maintain order via a message.

15. Method according to claim 1, further comprising the step of executing said maintenance offer automatically.

16. Computer program code that causes a processor to execute a database maintenance operation in a communication network, comprising program code means for performing all the steps of anyone of claims 1 to 15 when said program is run on a computer or a terminal device or in a distributed manner between a computer and a terminal device.

17. Computer program product comprising program code means stored on a computer readable medium for causing a processor to perform the method of anyone of claims 1 to 15 when said program product is run on a computer or terminal device or in a distributed manner between a computer and a terminal device.

18. Terminal device comprising
Means for storing used contact information;
Means for collecting data associated to used contact information;
Means for providing said contact information to the user; and
Means for offering maintenance operations of said contact database to a user based on said information and said associated data.

19. Terminal device of claim 18, further comprising means to automatically generate a message and means to automatically post a message to another terminal device.

20. Terminal device of claim 18, further comprising voice recognition means.

21. Terminal device of claim 18, wherein said terminal device is a mobile phone.

22. Terminal device of claim 18, wherein the terminal device is connected to, is incorporated in or comprises a computer device.

23. Server for maintaining a contact database in a network comprising means for
storing used contact information;
collecting data associated to used contact information;
providing said information to a user; and
offering maintenance operations of said contact database to a user based on said information and said associated data.

24. Server of claim 23, further comprising voice recognition means.

25. Server of claim 24 wherein the server further comprises a name dialling system.

26. Contact database maintenance system in a network, having
at least one terminal device,
at least one server, and
means for
storing used contact information;
collecting data associated to used contact information;
providing said information to a user; and
offering maintenance operations of said contact database to a user based on said information and said associated data.

27. Contact database maintenance system as claimed in claim 26, wherein said database is connected to, or comprises a name dialling system.

28. Contact database maintenance system as claimed in claim 26, comprising means for displaying said transferred message in said terminal device.

29. Contact database maintenance system according to claim 27, further comprising a voice recognition system.

30. Contact database maintenance system of claim 29, further comprising a voice pattern recognition system.

31. Contact database maintenance system according to claim 26, further comprising means to generate a user call statistics comprising the number of contacts made to a specific contact information in predetermined intervals.

32. Contact database maintenance system according to claims 26, further comprising means for deleting or adding a specific contact information and a related data from or to said directory in said database.

33. Contact database maintenance system of claim 29, wherein the voice recognition system is speaker-dependent.

34. Contact database maintenance system of claim 29, wherein the voice recognition system is speaker-independent.

35. Contact database maintenance system of claim 26, wherein modules of the system can be distributed between the terminal device and the network.

36. Contact database maintenance system of claim 26, wherein the means for voice dialling is distributed between the terminal device and a server.

37. Method according to claim 2, wherein the step of offering maintenance operations comprises an offering of a deletion of data from said database.

38. Method according to claim 8, wherein the contacted contact information are contacted to by voice dialling.

39. Terminal device of claim 20, wherein said terminal device is a mobile phone.
